(19) United States
(12) Patent Application Publication
(10) Pub. No.: US 2026/0037858 A1
(43) Pub. Date: Feb. 5, 2026

(54) CONTENT IDENTITY BASED DIGITAL CONTENT GENERATION

(71) Applicant: Adobe Inc., San Jose, CA (US)

(72) Inventors: Dhwanit Agarwal, San Jose, CA (US); Umang Moorarka, Bilaspur (IN); Shradha Agrawal, Milpitas, CA (US); Vangala Naveen Reddy, Hyderabad (IN); Kunal Kumar Jain, Chennai (IN); Ambareesh Revanur, San Jose, CA (US)

(73) Assignee: Adobe Inc., San Jose, CA (US)

(21) Appl. No.: 18/790,506

(22) Filed: Jul. 31, 2024

(51) Int. Cl. G06N 20/00

(52) U.S. Cl. CPC G06N 20/00

(57) ABSTRACT

Content identity based digital content generation is described. In an implementation, an input is received describing an item of digital content to be generated and a machine-learning model is selected from a plurality of machine-learning models based on the input, the plurality of machine-learning models trained, respectively, using training data expressing a content identity. A prompt is formed based on the input and the item of digital content as implementing the content identity using the selected machine-learning model based on the prompt. The item of digital content is presented for display in a user interface.

### BACKGROUND

Content identity is used as a basis to express a correlation between digital content as related to a particular identity through use as a brand, a style, a theme, and so forth. A content identity, for instance, is expressible using visual elements such as color, design, a logo, a “jingle,” and so forth such that a consumer of digital content that expresses the identity recognizes a corresponding correlation, e.g., to a particular entity associated with the brand, style, theme, and so forth.

Generative artificial intelligence (AI) has been developed to expand the ways, in which, digital content may be created using machine learning. Examples of which include to write text using a large language model (LLM), generate digital images using a diffusion model, digital audio generation, and so forth. Conventional generative AI techniques, however, encounter numerous technical challenges when tasked with generating digital content that is consistent with a content identity. These challenges are further exacerbated in instances in which changes are made to the content identity, itself.

### SUMMARY

Content identity based digital content generation is described in which generative artificial intelligence (AI) implemented using machine-learning models is usable to address technical challenges in managing content identity, even in situations in which a limited amount of training data is available. A content generation system, for instance, is configurable to address a content identity that is implemented using individual styles and concepts as a basis to train a plurality of machine-learning models that may be further aligned through a training-free feedback mechanism during inference. Inputs, (e.g., text inputs) are mapped to a corresponding identity-aligned machine-learning model during digital content generation.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures Entities represented in the figures are indicative of one or more entities and thus reference is made interchangeably to single or plural forms of the entities in the discussion.

FIG. 1 is an illustration of a digital medium environment in an example implementation that is operable to employ content identity based digital content generation techniques described herein.

FIG. 2 depicts a system showing operation of a generative artificial intelligence system of FIG. 1 in greater detail as implementing content identity based digital content generation.

FIG. 3 depicts an example implementation showing an input as text usable to generate an item of digital content as a digital image.

FIG. 4 depicts a system showing operation of a model tuning system of FIG. 2 of the generative artificial intelligence system in greater detail as training a plurality of machine-learning models using clustered training data.

FIG. 5 depicts a system showing operation of a training module of the model tuning system of FIG. 4 in greater detail as training adaptation machine learning models as examples of machine-learning models through use of a feedback mechanism.

FIG. 6 is a flow diagram depicting an algorithm as a step-by-step procedure in an example implementation of operations performable for accomplishing a result of machine-learning model training for content identity based digital content generation.

FIG. 7 depicts a system showing operation of an inference system of FIG. 2 in greater detail as generating digital content through use of the plurality of machine-learning models of FIG. 4.

FIG. 8 is a flow diagram depicting an algorithm as a step-by-step procedure in an example implementation of operations performable for accomplishing a result of content identity based digital content generation.

FIG. 9 is a flow diagram depicting an algorithm as a step-by-step procedure in an example implementation of operations performable for accomplishing a result of a two-pass background enhancement technique using feedback.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

### Overview

Generative artificial intelligence (AI) has been employed in a variety of usage scenarios to expand a variety and efficiency, at which, digital content is created. Generative AI is implemented using one or more machine-learning models to create a variety of forms of digital content, e.g., text, digital images, digital audio, digital videos, and so forth. As such, generative AI is usable in support of a variety of usage scenarios.

Once such scenario involves generation of digital content that conveys a content identity. As previous described, a content identity is expressible using visual elements such as color, design, a logo, digital audio as a “jingle” and so forth such that a viewer of digital content that expresses the identity recognizes a corresponding correlation, e.g., to a particular entity associated with the brand, style, theme, and so forth.

Conventional generative AI techniques, however, are challenged in these scenarios to accurately express the content identity. These challenges are further increased in scenarios in which a limited amount of training data is available to train the machine-learning models that implement the generative AI. A content identity, for instance, may be changed to include new or different visual or textual aspects having limited examples, involve a multitude of different aspects that are involved in implementing the content identity, involve proprietary images, and so forth.

Accordingly, content identity based digital content generation is described in which generative artificial intelligence (AI) implemented using machine-learning models is usable to address technical challenges in managing content identity, even in situations in which a limited amount of training data is available. A content generation system, for instance, is configurable to address a content identity that is implemented using individual styles and concepts as a basis to train multiple custom machine-learning models that may be further aligned through a training-free feedback mechanism during inference. Inputs, (e.g., text inputs) are then mapped to a corresponding identity-aligned machine-learning model during digital content generation, thus creating a seamless user experience.

In one or more examples, a content generation system includes a model tuning system and an inference system. The model tuning system is configurable to train machine-learning models by first clustering training data, e.g., content identity examples, text from a content brief defining content identity guidelines of the content identity, captions extracted from digital images, and so forth. Clusters of the training data are then used to train (e.g., “tune”) corresponding machine-learning models to exhibit corresponding aspects of the content identity, e.g., different characters, logos, styles, objects, and so forth.

Once trained, the inference system is usable to identify a trained machine-learning model that corresponds to an input describing the digital content to be generated, e.g., as text. An input, for instance, is converted to a vector using a machine-learning model which is then mapped to a corresponding machine-learning model based on similarity in an embedding space to the clustered training data used to train the machine-learning model. The mapped machine-learning model is then usable to generate the digital content as described by the input.

The content generation system is also configurable to address scenarios in which an amount of data that is available to train a corresponding machine-learning model is insufficient by itself to produce accurate results, e.g., a threshold of five or fewer items of content identity examples. In these scenarios, the content generation system detects that such a machine-learning model is to be used. In response, the content generation system leverages additional data to supplement the input as part of a prompt provided to the machine-learning model, which may be performed automatically and without user intervention. Examples of data added to the prompt include use of a content brief, a reference item of digital content (e.g., background images from preapproved assets that express the content identity), and so forth. As a result, accurate results may be achieved even in instances in which a limited amount of training data is available, e.g., for “new” aspects of a content identity, proprietary content, and so forth.

Thus, the content generation system is configurable to implement a pipeline supporting generation of digital content that is aligned with a content identity. The pipeline supports content selection as part of training as well as content generation using the trained models, automatically and without user intervention. The content generation system, for instance, is configurable to operate in scenarios having limited content identity examples, which is not possible using conventional techniques.

The content generation system is also configurable to address regression in background quality using a reference item of digital content by using a two pass inference technique that employs masked weighted self-attention with the trained machine-learning models. This technique supports generation of digital content that is aligned with a content identity having a background with improved appearance. Further, this technique is performable “training free,” which is also not possible in convention techniques. A training-free feedback mechanism is also supported using masked weighted self-attention. This mechanism is usable to employ feedback “on-the-fly” to align the digital content generation that expresses the content identity with user preferences. Further discussion of these and other examples is included in the following discussion and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Content Generation Environment

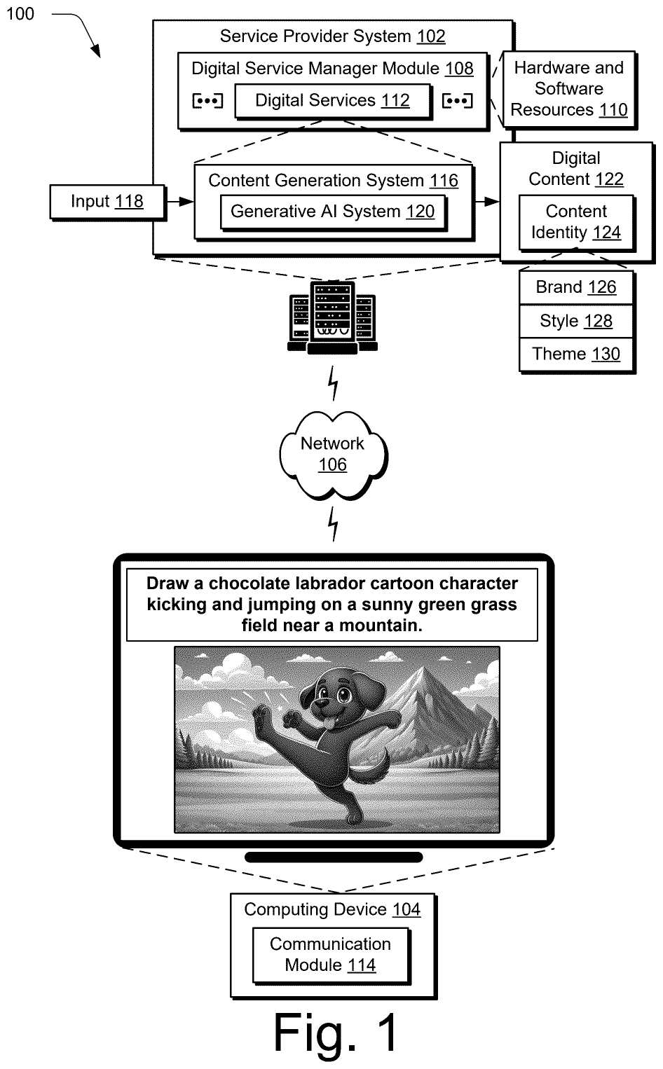

FIG. 1 is an illustration of a digital medium environment 100 in an example implementation that is operable to employ content identity based digital content generation techniques described herein. The illustrated environment 100 includes a service provider system 102 and a computing device 104 that are communicatively coupled, one to another, via a network 106. Computing devices are configurable in a variety of ways.

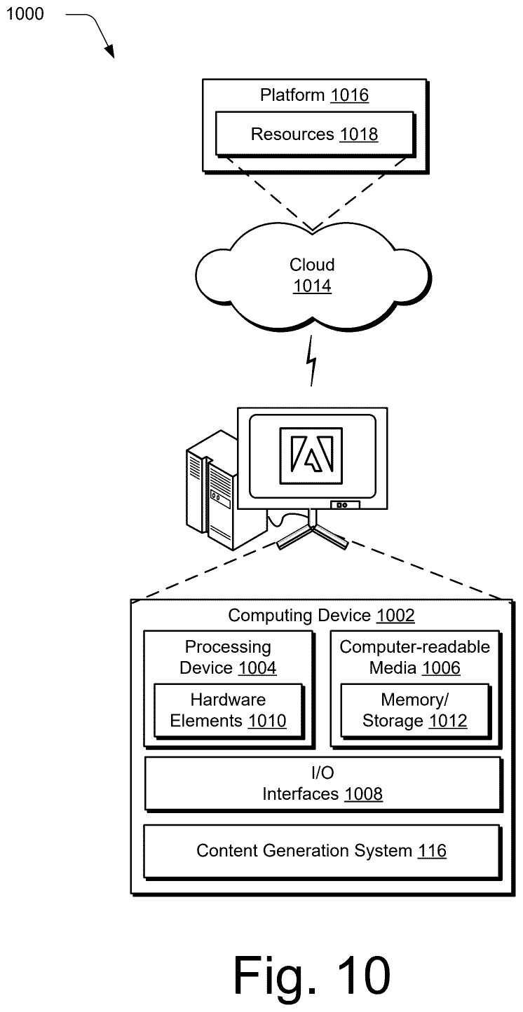

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 10.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a content generation system 116, although the content generation system 116 may also be implemented locally in whole or in part at the computing device 104, e.g., by the communication module 114. The content generation system 116 is configured to receive an input 118 that specifies an item of digital content to be generated. The content generation system 116 then employs a generative AI system 120 to generate digital content 122 that expresses and/or is consistent with a content identity 124, e.g., as a digital image, digital audio, digital video, webpage, email, and so forth. The content identity 124, for instance, is usable to express a brand 126, a style 128, a theme 130, and so forth.

A content identity 124, such as a brand 126, typically involves use of a large repository of digital content that includes digital images, a content brief specifying content identity guidelines, and so forth that are to be used for digital content associated with an entity, e.g., for digital marketing, general usage scenarios, and so forth. With the advent of generative AI, there have been efforts to automate and accelerate digital content creation, e.g., using generative diffusion models, large language models, and so forth. However, technical challenges lie in generating digital content that is aligned with the identity guidelines, a brand's existing assets/IP, and so forth.

Further, “off-the-shelf” models are not usable for this purpose as these items are often proprietary and protected and thus not available for training, e.g., use of copyrighted and/or trademarked characters, logos, and so forth. Additionally, a content identity often involves a variety of different styles and concepts. As a result, a sufficient amount of digital content for training is not available in a variety of real-world scenarios, e.g., for a “new” content identity, a proprietary identity, and so forth. Even if a significant amount of training data is available, inaccuracies occur in real world scenarios in generating digital content that while having a similar visual appearance does not comply with the guidelines, e.g., the “colors are off.”

Accordingly, to address these and other technical challenges the content generation system 116 is configured to implement a comprehensive system architecture usable to train and align multiple machine-learning models of a generative AI system 120 to automate and accelerate digital content generation. The content generation system 116 is configurable to leverage a content brief defining content identity guidelines of the content identity, content identity examples, text (e.g., captions) extracted from digital images using machine-learning models, and so forth as part of training machine-learning models and use the machine-learning models at inference to generate the digital content 122.

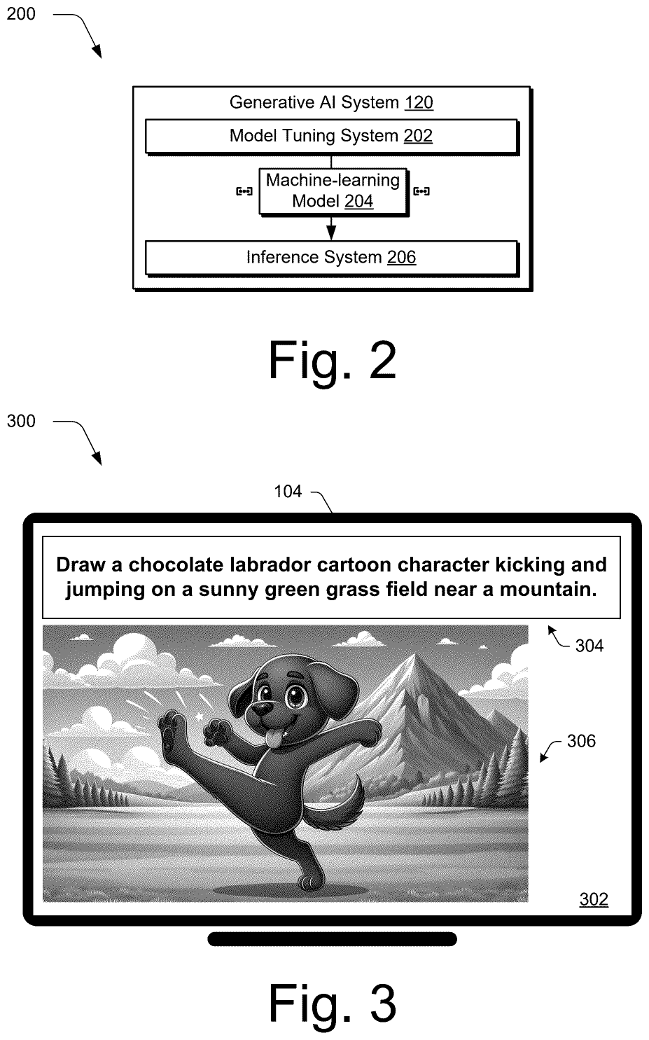

FIG. 2 depicts a system 200 showing operation of the generative AI system 120 of FIG. 1 in greater detail as implementing content identity based digital content generation. The content generation system 116 includes a model tuning system 202 that is configured to train a plurality of machine-learning models 204 as part of the generative AI system 120. Once trained, the plurality of machine-learning models 204 are employed by an inference system 206 to generate the digital content 122.

The model tuning system 202, for instance, is configured for “finetuning” of the plurality of machine-learning models 204 to address different aspects of the content identity 124. Once trained, the inference system 206 is configured to select one or more of the plurality of machine-learning models 204 to process an input 118 based on correspondence with of training data used to train the models with the input 118, e.g., text of the input. As a result, the selection is performable independent of user input, i.e., the user does not manually select the “correct” machine-learning model. The inference system 206 is also configurable to supplement processing of the input by including tags associated with digital images, captions extracted from the digital images using machine learning, and so on as further described below.

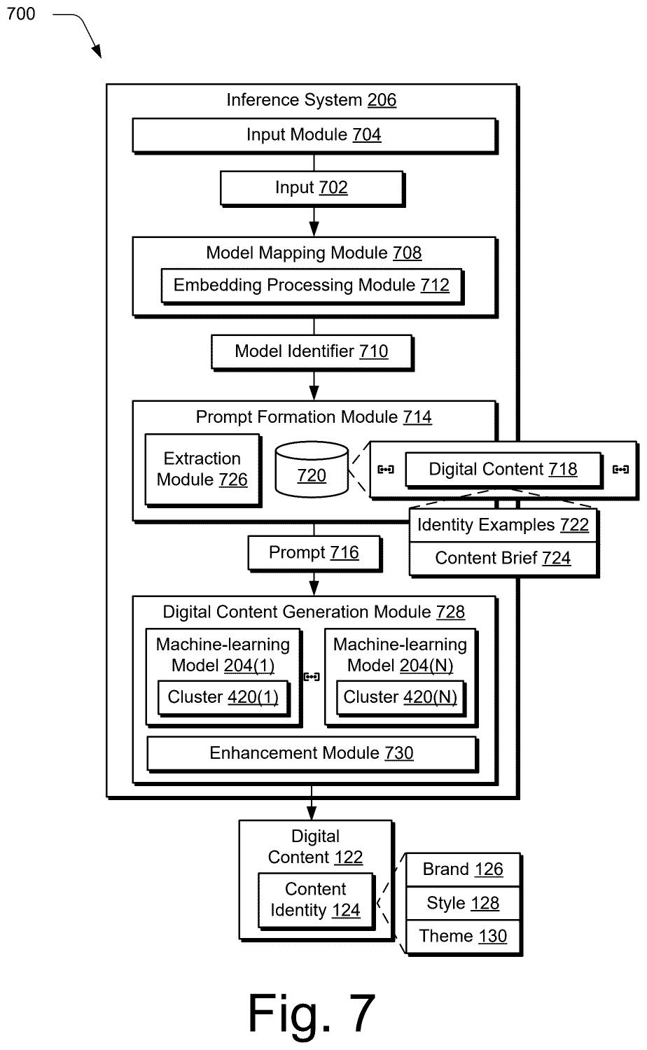

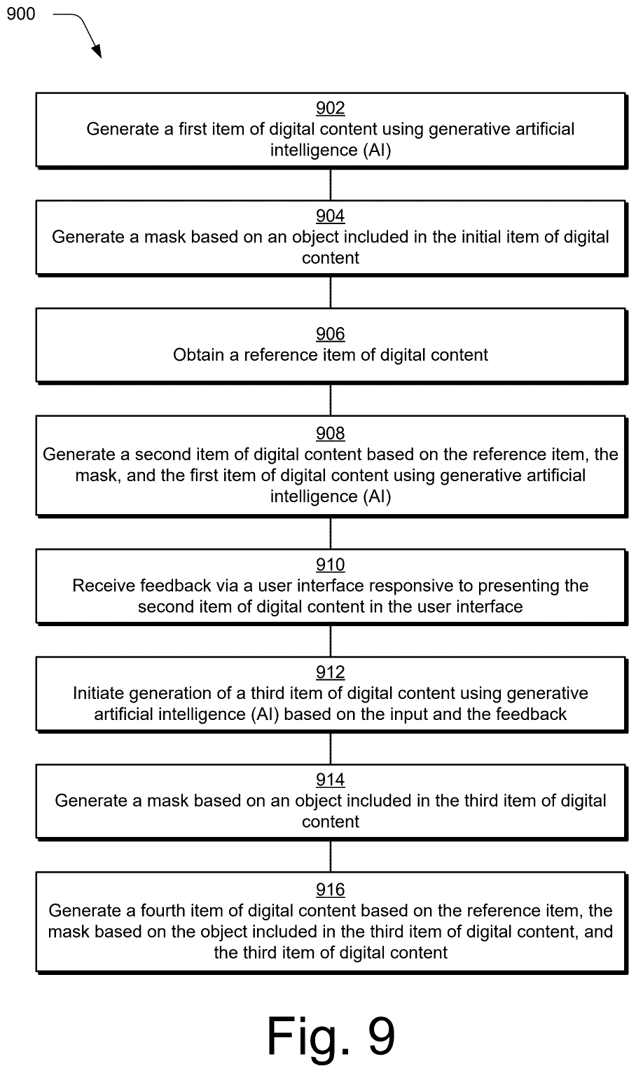

The generative AI system 120 is configurable to identify multiple concepts and styles of a content identity 124 by clustering training data. If there is a suitable number of assets, machine-learning models 204 are trained by automatically selecting assets from a corresponding cluster of training data. Otherwise, in one or more examples additional data is obtained, e.g., by extracting captions from content identity examples, a content brief, tags, and so forth. During generation of the digital content, the inference system 206 automatically maps an input to a corresponding machine-learning model trained for a respective styles or concepts that may exist under as part of a content identity. In an implementation as further described in relation to FIGS. 7 and 9, a two-pass inference technique is also supported as part of digital content generation using masked weighted self-attention integrated with the trained machine-learning models, e.g., to offer background enhancement and prompt alignment in a training-free manner. Feedback is also supported for additional content identity alignment “on-the-fly.”

FIG. 3 depicts an example implementation 300 showing an input as text usable to generate an item of digital content as a digital image. As illustrated, the computing device 104 outputs a user interface 302. The user interface 302 includes an example 304 of the input 118 as text that specifies digital content to be generated, e.g., “draw a chocolate labrador cartoon character kicking and jumping on a sunny green grass field near a mountain.” The user interface 302 also includes an example 306 of the generated digital content 122 as a digital image having a cartoonish image of a brown dog and a mountainous background. In this example, the dog is generated as consistent with a character associated with a content identity 124 through use of a corresponding machine-learning model trained to generate that character. Further discussion of these and other examples is included in the following section.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Content Generation Based on a Content Identity

The following discussion describes digital content generation techniques based on a content identity that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

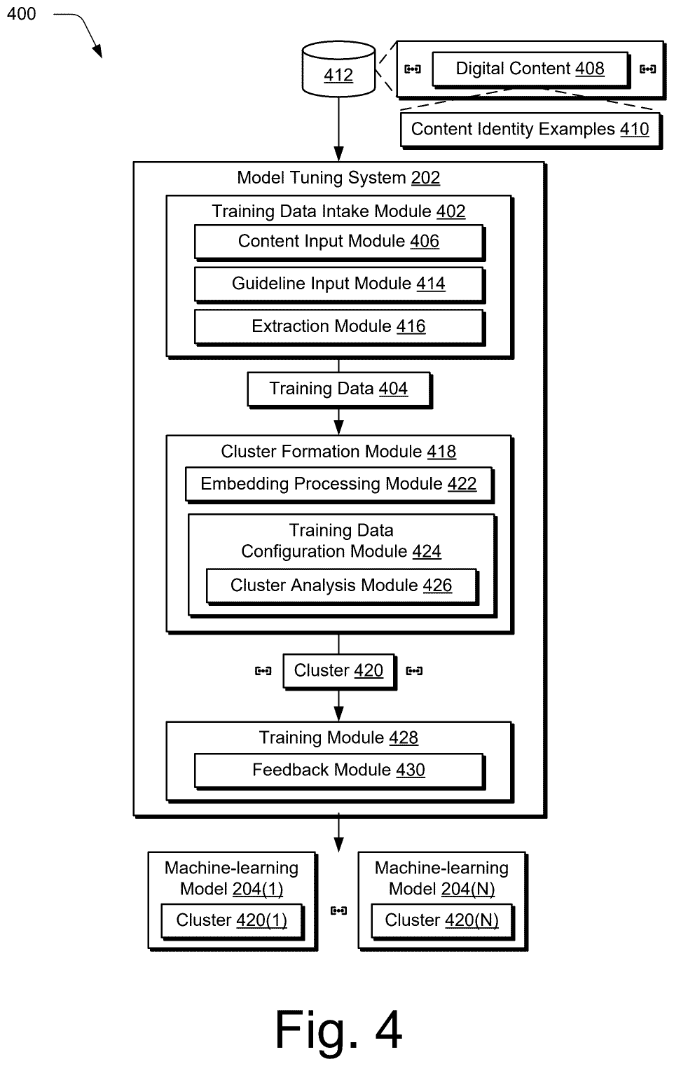

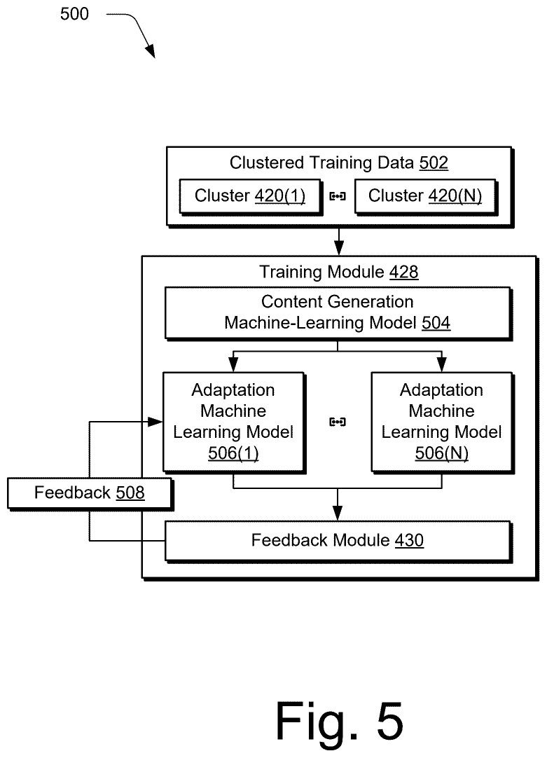

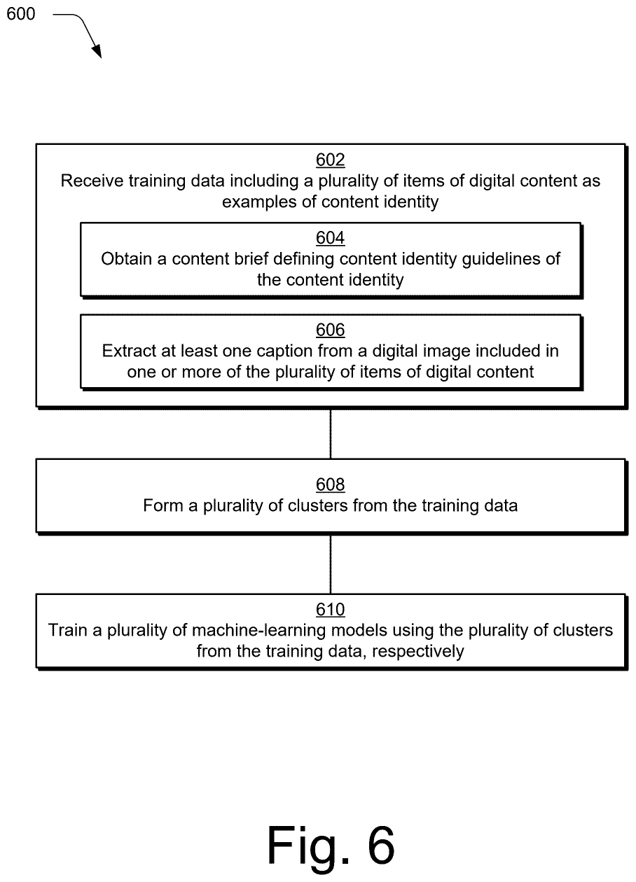

FIG. 4 depicts a system 400 showing operation of the model tuning system 202 of FIG. 2 in greater detail as training plurality of machine-learning models 204 using clustered training data. FIG. 5 depicts a system 500 showing operation of a training module of the model tuning system 202 of FIG. 4 in greater detail as training adaptation machine learning models as examples of machine-learning models through use of a feedback mechanism. FIG. 6 is a flow diagram depicting an algorithm 600 as a step-by-step procedure in an example implementation of operations performable for accomplishing a result of machine-learning model training for content identity based digital content generation. In the following discussion, reference is made in parallel to the systems 400, 500 of FIGS. 4 and 5 with the algorithm 600 of FIG. 6.

To begin in this example, training data is received that includes a plurality of items of digital content as examples of content identity (block 602). A training data intake module 402, for instance, is configurable to collect training data 404 that expresses a content identity. For example, a content input module 406 is first usable to collect digital content 408 containing content identity examples 410 from a storage device 412. The digital content 408 is configurable in a variety of ways as previously described, including digital documents, digital images, slides from a presentation, digital media, webpages, digital audio, digital video, and so forth. Digital images, for instance, may depict an object having colors in accordance with a brand as well as include tags as metadata associated with the digital image describing the objects, semantics, visual characteristics, and so forth. Digital audio is configurable to include a series of musical notes in a readily identifiable sequence. A variety of other instances are also contemplated.

In another example, a guideline input module 414 is configured to obtain a content brief defining content identity guidelines of the content identity (block 604). The content brief, for instance, may include text and digital images to describe a logo including color, sizes, and variations approved for the logo. The content brief may also specify overall colors associated with a brand 126, typography including fonts and sizes, design elements including shapes and illustrates, preapproved reference materials, a mission statement, approved voice and tone for wording in text and digital videos, and so forth.

In a further example, an extraction module 416 is configured to extract text from digital images. The extraction module 416, for instance, is configurable to extract tags as metadata associated with digital images. The tags may describe styles and other information specified by an entity that is associated with creation of the digital image that is then usable to locate the digital image, e.g., as part of a keyword search. In another example, the extraction module 416 is configured to implement a machine-learning module to extract a caption as text by processing digital images using machine learning by a machine-learning model (block 606). A variety of other extraction instances are also contemplated.

The training data 404 is then passed as an input from the training data intake module 402 for receipt by a cluster formation module 418. The cluster formation module 418 is configured to form a plurality of clusters 420 from the training data 404 (block 608). The cluster formation module 418, for instance, is configurable to cluster the training data 404 using an embedding processing module 422 based on similarity of embeddings formed from the training data 404 by a machine-learning model within an embedding space, e.g., based on Cosine similarity of respective vectors in the embedding space.

A training data configuration module 424 may also be employed to configure training data included within the clusters 420 for training purposes. The training data configuration module 424, for instance, is configurable to determine whether a threshold amount of training data is available in a respective cluster using a cluster analysis module 426, e.g., that is likely sufficient to train a respective machine-learning model to produce accurate results.

If not (e.g., a number of items is five or less), the cluster analysis module 426 is configured to supplement the cluster 420 with additional training data. The cluster analysis module 426, for example, is configurable to add one or more captions extracted using machine learning from at least digital image, add data from a content brief defining content identity guidelines of the content identity, add tags associated with digital images from the content identity examples 410, and so forth. In this way, the cluster analysis module 426 is able to promote accuracy in model training.

The clusters 420 of the training data 404 are then passed to a training module 428. The training module 428 is configured to train a plurality of machine-learning models 204(1)-204(N) using the plurality of clusters 420(1)-420(N) from the training data, respectively (block 610). Accordingly, each of the models is trained for a specific cluster that corresponds to different aspects of the content identity 124, e.g., logos, characters, mottos, media types (e.g., email, webpages), communication channels, and so forth. The training is performable in a variety of ways, including training machine-learning models “from scratch,” additional training performed for pretrained models, training of additional machine-learning models configured to adapt to pretrained models, and so forth. Feedback mechanisms are also supported through use of a feedback module 430, further discussion of which is include in the following description and shown in a corresponding figure.

FIG. 5 depicts a system 500 showing operation of a training module of the model tuning system 202 of FIG. 4 in greater detail as training adaptation machine learning models as examples of machine-learning models through use of a feedback mechanism. The training module 428 in this example receives the clustered training data 502 forming clusters 420(1), . . . , 420(N), e.g., for particular characters, logos, and so forth. A content generation machine-learning model 504 is employed in this example along with a plurality of adaptation machine-learning models 506(1), 506(N) for training, respectively, by each of the clusters 420(1), 420(N).

An example of the adaptation machine-learning models 506(1), 506(N) includes a low-rank adaptation (LoRA) machine-learning model that is used to fine tune large pre-trained models, e.g., the content generation machine-learning model 504 as a large language module, diffusion model, and so forth. The adaptation machine-learning models 506(1), 506(N) are used in this example that instead of retraining the parameters of the content generation machine-learning model 504, a low-rank matrix is utilized to capture the essence of updates expressed by the respective clusters 420(1), 420(N).

In this way, the adaptation machine-learning models 506(1), 506(N) are usable for adapting the content generation machine-learning model 504 to specific tasks without (i.e., independent of) a full fine-tuning training operation. This technique supports adaption of the content generation machine-learning model 504 to specific tasks, which in this instance is aspects of the content identity 124, while also maintaining the previously trained general capabilities of the model. A variety of other examples are also contemplated.

The training module 428 in this example also employs a feedback module 430. The feedback module 430 is representative of a feedback mechanism to provide feedback 508 to further train the adaptation machine-learning models 506(1), 506(N). The feedback mechanism, for instance, is usable to provide feedback as “likes” or “dislikes” to the adaptation machine-learning models 506(1), 506(N) to adjust weights during use by the inference system 206 during operation to generate the digital content 122 having the content identity 124.

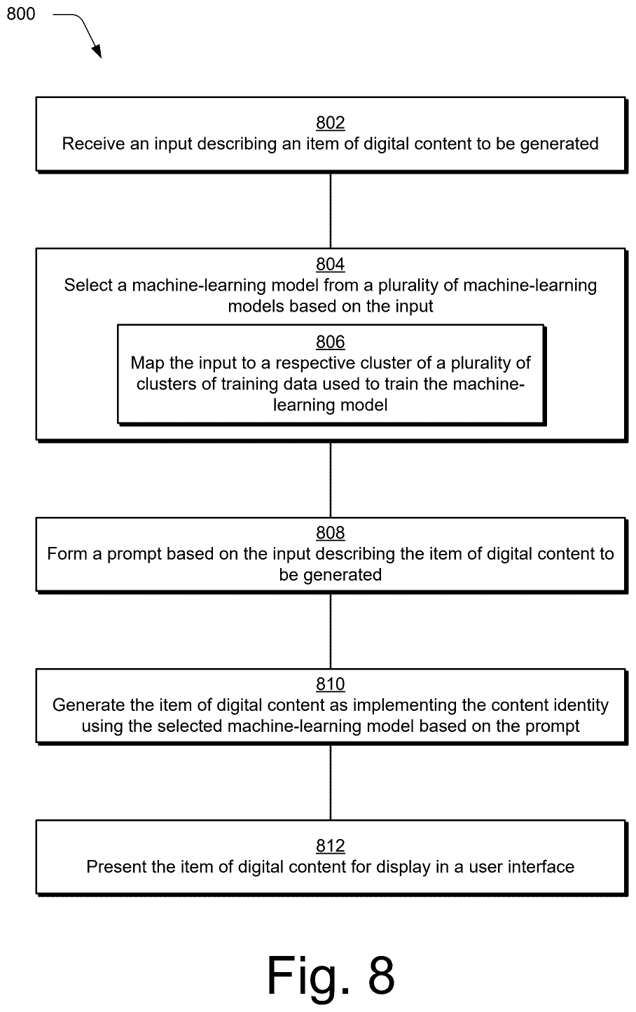

FIG. 7 depicts a system 700 showing operation of the inference system 206 of FIG. 2 in greater detail as generating digital content 122 through use of the plurality of machine-learning models of FIG. 4. FIG. 8 is a flow diagram depicting an algorithm 800 as a step-by-step procedure in an example implementation of operations performable for accomplishing a result of content identity based digital content generation. In the following discussion, reference is made in parallel to the system 700 of FIG. 7 with the algorithm 800 of FIG. 8.

To begin in this example, an input 702 is received by an input module 704 describing an item of digital content to be generated (block 802). The input 702, for instance, is received via a user interface 302 and is configurable as a text description describing characteristics of the digital content 122 to be generated, a digital image, a spoken utterance, and so forth.

The input 702 is then passed to a model mapping module 708. The model mapping module 708 is configured to select a machine-learning model from a plurality of machine-learning models based on the input 702 (block 804), which is output as a model identifier 710. In one or more examples, the input 702 is mapped to a respective cluster of a plurality of clusters of training data used to train the machine-learning model (block 806). An embedding processing module 712, for instance, is configurable to generate an embedding as a vector based on the input 702, e.g., using natural language processing as implemented by a machine-learning model. A similarity determination is then made with respect to the clusters 420(1), 420(N) of training data 404 used to train respective machine-learning models 204(1), 204(N) using embeddings formed from the training data, e.g., Cosine similarity. In this way, the model mapping module 708 is configurable to map the input 702 to a respective machine-learning model that has been trained to generate a corresponding aspect of the content identity 124.

A prompt formation module 714 is then employed to form a prompt 716 based on the input 702. As previously described, the input 702 describes the item of digital content to be generated (block 808). The prompt formation module 714 is then configurable to form the prompt 716 from the input 702 in a form that is consumable by a machine-learning model, e.g., using one or more templates that serve as a basis to configure the request as well as examples of an output format.

The prompt formation module 714 is also configurable to supplement the input 702 as part of the prompt 716. The prompt formation module 714, for instance, based on the model identifier 710 determines that a respective machine-learning model has not been trained in a manner sufficient to comply with a minimal quality guarantee, e.g., has been trained on five or fewer items of training digital content. In this instance, the prompt formation module 714 is configured to supplement the input 702. In a first example, digital content 718 is selected from a repository 720, examples of which include identity examples 722, a content brief 724, and so on. The identity examples 722, for instance, include a collection of templates and other examples usable to express aspects of the brand 126, style 128, theme 130, and so forth of the content identity 124. The content brief 724 describes content identity guidelines of the content identity 124. The content brief 724, for instance, may include text and digital images to describe a logo including color, sizes, and variations approved for the logo. The content brief 724 may also specify overall colors associated with a brand 126, typography including fonts and sizes, design elements including shapes and illustrates, preapproved reference materials, a mission statement, approved voice and tone for wording in text and digital videos, and so forth.

In another example, an extraction module 726 is employed to extract text from the digital content 718. The digital content 718, for instance, may include tags included as part of metadata associated with the digital content 718 that describes objects included in the digital content 718, styles, colors, semantics, and so forth. In another example, the extraction module 726 is configured to identify text by processing the digital content 718. The extraction module 726, for instance, is configurable to utilize caption generation techniques in which a machine-learning model employs classification to derive text that describes characteristics of the digital content 718. A variety of other examples are also contemplated.

The item of digital content is generated as implementing the content identity using the selected machine-learning model based on the prompt 716 (block 810) by a digital content generation module 728. The machine-learning model, for instance, is obtained and configured from the plurality of machine-learning models 204(1), 204(N) as being trained using a cluster 420(1), 420(N) that corresponds to the input 702. The selected machine-learning model then processes the prompt 716 to generate the digital content 122 as having the content identity 124, e.g., the brand 126, style 128, theme 130, and so on. The prompt 716, as previously described, is configurable to include the input 702 and may be supplemented using captions, identity examples 722, content brief 724, a reference item of digital content, and so forth. The item of digital content 122, once generated, is then presented for display in a user interface 302 (block 812) by the content generation system 116.

As a result, the generative AI system 120 is configured to implement a variety of usage scenarios through use of the model tuning system 202 and the inference system 206. In a first example, the generative AI system 120 receives training data 404 that includes examples that include and are independent of a content identity 124. In instances in which a threshold number of items of digital content are available (e.g., five to ten items), auto-captioning is performed for digital images included in the items as part of training a respective machine-learning model by the model tuning system 202. The inference system 206 then generates the digital content 122 based on the prompt 716, which may include the input 702, identity examples 722, content brief 724, captions, and so forth.

In instances in which a threshold number is not available, style tags, styles, and content guidelines are used to supplement training of a respective machine-learning model. In an instance in which digital images are not available but content guidelines as expressed in a content brief are available, the guidelines are used. The inference system 206 then generates the digital content 122, which may include use of a background enhancement technique as further described below.

FIG. 9 is a flow diagram depicting an algorithm 900 as a step-by-step procedure in an example implementation of operations performable for accomplishing a result of a two-pass background enhancement technique using feedback through use of an enhancement module 730 of FIG. 7. In this example, a reference item of digital content is configured for inclusion as part of the prompt 716 to aid generation by the inference system 206 of the digital content 122. Generalized machine-learning models, in some instances, suffer from regression in a quality and diversity of a background generated for a digital image as part of the digital content 122. Additionally, alignment issues arise, e.g., in which a prompt specifying “sunny” causes a sunny foreground but is not populated to a background. Accordingly, in this example a reference item of digital content is employed to leverage brand-approved assets as a basis for developing subsequent items of digital content.

To do so, two-pass inference is employed using a base content generation machine-learning model 504 in conjunction with adaptation machine-learning models 506(1), 506(N). An initial item of digital content that includes a digital image is generated. A mask is then generated for an object in the digital image, with latent values copied in the masked region while using weighted self-attention on the background features of the reference item of digital content to generate the background.

For example, as previously described a machine-learning model is selected from a plurality of machine-learning models based on an input. The plurality of machine-learning models is trained, respectively, using training data that expresses a content identity. Generation of a first item of digital content is initiated using generative artificial intelligence (AI) based on the input (block 902). A mask based on an object included in the first item of digital content (block 904) and a reference item of digital content is obtained (block 906), e.g., as specified via a user interface. A second item of digital content is then generated based on the reference item, the mask, and the first item of digital content using generative artificial intelligence (AI) (block 908).

Feedback is received, via a user interface, responsive to presenting the second item of digital content in the user interface (block 910) and in response generation of a third item of digital content using generative artificial intelligence (AI) based on the input and the feedback (block 912), e.g., a “like” or “dislike” as indicating the output is or is not suitable. Again, a mask is generated based on an object included in the third item of digital content (block 914) and a fourth item of digital content based on the reference item, the mask based on the object included in the third item of digital content, and the third item of digital content (block 916). In this way, the content generation system 116 protects against background regression and as such addresses conventional technical challenges.

### Example System and Device

FIG. 10 illustrates an example system generally at 1000 that includes an example computing device 1002 that is representative of one or more computing systems and/or devices that implement the various techniques described herein. This is illustrated through inclusion of the content generation system 116. The computing device 1002 is configurable, for example, as a server of a service provider, a device associated with a client (e.g., a client device), an on-chip system, and/or any other suitable computing device or computing system.

The example computing device 1002 as illustrated includes a processing device 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1004 is representative of functionality to perform one or more operations using hardware. Accordingly, the processing device 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012 that stores instructions that are executable to cause the processing device 1004 to perform operations. The computer-readable storage medium is configured for storing instructions that, responsive to execution by the processing device, causes the processing device to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing device 1004. The instructions and/or functions are executable/operable by one or more articles of manufacture (for example, one or more computing devices 1002 and/or processing devices 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

In implementations, the platform 1016 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, an input describing an item of digital content to be generated;
selecting, by the processing device, a machine-learning model from a plurality of machine-learning models based on the input, the plurality of machine-learning models trained, respectively, using training data expressing a content identity;
forming, by the processing device, a prompt based on the input describing the item of digital content to be generated;
generating, by the processing device, the item of digital content as implementing the content identity using the selected machine-learning model based on the prompt; and
presenting, by the processing device, the item of digital content for display in a user interface.

2. The method as described in claim 1, wherein the training data includes a content brief defining content identity guidelines of the content identity.

3. The method as described in claim 1, wherein the training data includes one or more captions as text generated using a machine-learning model from one or more digital images that exhibit the content identity.

4. The method as described in claim 1, wherein the plurality of machine-learning models is trained, respectively, using a plurality of clusters of the training data that exhibit the content identity.

5. The method as described in claim 4, wherein the selecting includes mapping the input to a respective said cluster of the plurality of clusters of the training data used to train the machine-learning model.

6. The method as described in claim 5, wherein the mapping includes mapping an embedding formed from the input using a machine-learning model with embeddings formed from the plurality of clusters of the training data, respectively.

7. The method as described in claim 1, wherein the generating the digital content includes:
generating a first item of digital content using generative artificial intelligence (AI);
generating a mask based on an object included in the first item of digital content;
obtaining a reference item of digital content; and
generating the digital content based on the reference item, the mask, and the first item of digital content using generative artificial intelligence (AI).

8. The method as described in claim 1, wherein the forming of the prompt includes:
adding one or more captions extracted using machine learning from at least digital image; or
adding data from a content brief defining content identity guidelines of the content identity.

9. The method as described in claim 8, wherein the adding the one or more captions or the adding the data is performed responsive to an indication that a threshold amount training data that expresses the content identity is not used to train the machine-learning model.

10. A method comprising:
selecting, by a processing device, a machine-learning model from a plurality of machine-learning models based on an input, the plurality of machine-learning models trained, respectively, using training data that expresses a content identity;
initiating, by the processing device, generation of a first item of digital content using generative artificial intelligence (AI) based on the input;
generating, by the processing device, a mask based on an object included in the first item of digital content;
obtaining, by the processing device, a reference item of digital content; and
generating, by the processing device, a second item of digital content based on the reference item, the mask, and the first item of digital content using generative artificial intelligence (AI).

11. The method as described in claim 10, further comprising:
receiving feedback via a user interface responsive to presenting the second item of digital content in the user interface;
initiating, by the processing device, generation of a third item of digital content using generative artificial intelligence (AI) based on the input and the feedback;
generating, by the processing device, a mask based on an object included in the third item of digital content; and
generating, by the processing device, a fourth item of digital content based on the reference item, the mask based on the object included in the third item of digital content, and the third item of digital content.

12. The method as described in claim 10, further comprising forming a prompt based on the input describing the item of digital content to be generated and wherein the generating the second item of digital content is based on the prompt.

13. The method as described in claim 12, wherein the forming of the prompt includes:
adding one or more captions extracted using machine learning from at least one digital image; or
adding data from a content brief defining content identity guidelines of the content identity.

14. The method as described in claim 13, wherein the adding the one or more captions or the adding the data is performed responsive to an indication that a threshold amount training data that expresses the content identity is not used to train the machine-learning model.

15. One or more computer-readable storage media storing instructions that, responsive to execution by a processing device, causes the processing device to perform operations comprising:
receiving training data including a plurality of items of digital content as examples of content identity;
forming a plurality of clusters from the training data; and
training a plurality of machine-learning models using the plurality of clusters from the training data, respectively.

16. The one or more computer-readable storage media as described in claim 15, wherein the operations further comprise extracting at least one caption from a digital image included in one or more of the plurality of items of digital content and wherein the training data includes the at least one caption.

17. The one or more computer-readable storage media as described in claim 15, wherein the training data includes a content brief defining content identity guidelines of the content identity.

18. The one or more computer-readable storage media as described in claim 15, further comprising:
selecting a machine-learning model from the plurality of machine-learning models based on an input; and
generating the item of digital content as implementing the content identity using the selected machine-learning model; and

19. The one or more computer-readable storage media as described in claim 18, the operations further comprising forming a prompt based on an input describing the item of digital content to be generated and wherein the generating the item of digital content is based on the prompt.

20. The one or more computer-readable storage media as described in claim 19, wherein the forming of the prompt includes adding one or more captions extracted using machine learning from at least digital image or adding data from a content brief defining content identity guidelines of the content identity.
